(19) United States
(12) Patent Application Publication
(10) Pub. No.: US 2008/0243595 A1
(43) Pub. Date: Oct. 2, 2008

(54) Information processing device, information processing method and information processing program

(75) Inventors: Takeshi Kumazawa, Kawasaki (JP); Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,288

(22) Filed: Feb. 19, 2008

(30) Foreign Application Priority Data
Mar. 28, 2007 (JP) JP2007-0085190

(51) Int. Cl. G06F 17/30

(52) U.S. Cl. 705/10

(57) ABSTRACT

An information processing device 1 comprising an input/output unit 7, a user information storage unit 13 stored with identifying information, information on a profile and information on a course participation history of a course, a Website 9 organized by a plurality of Web pages in different categories, a course information storage unit 15 stored on information on the course, a course distributing unit 10 transmitting text data of contents of the course, a course information storage unit 15 recorded with contents of the transmitted utilizing information, an analyzing unit 11 extracting the course along with the favorite of the user, and an announcement distributing unit 12 transmitting an announcement of the extracted course.

This application claims the benefit of Japanese Patent Application No. JP2007-085190 filed on Mar. 28, 2007 in the Japanese Patent Office, the disclosure of which is herein incorporated in its entirety by reference.

### BACKGROUND OF THE INVENTION

The present invention relates to an information processing method, and information processing method and an information processing program.

Nowadays, Websites on the internet distribute various categories of information. The information distributed by the Websites is classified into useful information and useless information to users.

For example, Patent document 1 describes a technology of opening a cyber-showroom on the Internet and reducing costs for management to a greater degree than in the case of opening a real showroom. Further, Patent document 2 describes a technology of searching for another related commercial article related to a commercial article selected by a customer, then recommending the customer purchasing this related commercial article, and thus preventing an omission etc of the purchase of the commercial article. Still further, Patent document 3 describes a technology of accumulating pieces of information on the commercial articles purchased by the customer, searching for a succeeding commercial article to the commercial article purchased in the past by the customer, then proposing the succeeding commercial article to the customer, and minimizing a cost for shifting to the succeeding commercial article. Yet further, Patent document 4 describes a technology of analyzing an attribute and a favorite of every customer, generating on a customer-by-customer-basis a customer-oriented recommendation advertisement on the basis of the analyzed result, then distributing the recommendation advertisement, and thus improving both a probability of response from the customer and a cost-to-investment effect. Moreover, Patent document 5 describes a technology of accumulating customer's individual information and pieces of information on a car owned by the customer, parts thereof and a repair service in a database, predicting a commercial article and a service having a possibility that the customer will purchase or utilize next time on the basis of the accumulated information and data of a purchase history at each shop, and transmitting these items of information to communication terminal equipment of the customer. Furthermore, Patent document 6 describes a technology of executing a process of matching the information such as a profile, an access log and an event participation history of the customer with the information to be distributed, and distributing an electronic mail having a content coincident with an interesting field of the customer. Additionally, Patent document 7 describes a technology of recording a behavior (such as browsing the detailed description, registering in a basket and an actual purchase) of the user as a score, then extracting and notifying of the commercial article having a large score when accessed from the user, and thus recommending the commercial article in which the needs of the user are reflected while reducing a load applied on the system. Moreover, Patent document 8 described a technology of making the customer carry a transmission terminal for transmitting a customer identification ID for identifying an individual (customer), then transmitting, when an ID receiving terminal disposed in the vicinity of the commercial article receives a signal transmitted from the transmission terminal, a customer identification ID and an individual (article) identification ID for identifying the commercial article to the information terminal, and getting the customer to grasp a customer's own favorite even when the customer does not purchase the commercial article displayed at the shop window.

[Patent document 1] Japanese Patent Laid-Open Publication No. 2001-256357

[Patent document 2] Japanese Patent Laid-Open Publication No. 2001-265852

[Patent document 3] Japanese Patent Laid-Open Publication No. 2004-326502

[Patent document 4] Japanese Patent Laid-Open Publication No. 2004-46568

[Patent document 5] Japanese Patent Laid-Open Publication No. 2005-346362

[Patent document 6] Japanese Patent Laid-Open Publication No. 2001-175761

[Patent document 7] Japanese Patent Laid-Open Publication No. 2003-150835

[Patent document 8] Japanese Patent Laid-Open Publication No. 2006-48295

### SUMMARY OF THE INVENTION

Those technologies have, however, the following problems. To be specific, according to the technologies described above, the information along with the general favorite of the user is uniformly provided, but any information for effectively utilizing usage equipment of the user is not distributed. For example, if usage-unknown software etc is installed into a computer terminal of the user, a usage of the software and an announcement of a new product are not recommended to the user, with the result that the equipment is not effectively utilized.

Such being the case, the present invention aims at providing an information processing device, an information processing method and an information processing program, which provide the information for effectively utilizing the usage equipment of the user along with the favorite of the user.

In order to solve the problems given above, the present invention has a scheme of analyzing the favorite of the user on the basis of an access status etc to a Web page, and transmitting information for effectively utilizing the usage equipment of the user along with the analyzed result.

Specifically, an information processing device comprises: an input/output unit used for performing communications with usage equipment of a user via a communication network; a user information storage unit stored with identifying information for identifying the user, information on a profile of the user and information on a course participation history of a course in which the user participated; a Website accessed by the user and organized by a plurality of Web pages in different categories; an access recording unit recording information on the user accessing the Website; a course information storage unit stored with text data of contents of the course that contains information on a usage method of the usage equipment and with text data of an announcement of the course that summarizes the contents of the course; a course distributing unit transmitting, when receiving a request from the user, the text data of contents of the course to the usage equipment of the user via the input/output unit, and updating the course participation history stored in the user information storage unit; an analyzing unit searching for a relationship between the course in which the user participated and a profile of the user by referring to the user information storage unit, searching for a relationship between the category of the Web page accessed by the user and the profile of the user by referring to the access recording unit, and extracting, from within the courses stored in the course information storage unit, the course that satisfies conditions of the searched relationships between the profile of the user, the participation course and the category of the Web page; and an announcement distributing unit searching the course information storage unit for the text data of the announcement of the course matching with the course extracted by the analyzing unit, and transmitting the searched text data of the announcement of the course to the usage equipment of the user.

The information processing device according to the present invention includes the input/output unit and has a communication-enabled configuration with the usage equipment of the user via the communication network. Further, the information processing device includes the user information storage unit stored with the various categories of information, the access recording unit, the course information storage unit, the Website, the course distributing unit, the analyzing unit and the announcement distributing unit.

The user information storage unit is stored with the information on the user. Namely, the user information storage unit is stored with the identifying information for identifying the user having an access via the communication network, the information on the profile used when analyzing the favorite of the user, and the information on the course participation history of the course in which the user participated. These items of information are the information previously stored by an operator etc on the basis of the information registered by the user, etc. Herein, the “profile” connotes information on the user, such as a distinction of sex and an age group of the user.

The Website is organized by the plurality of Web pages in the different categories, and is accessed by the user. The information on the user accessing the Website is recorded on the access recording unit as an access log.

The course distributing unit transmits the information to the usage equipment of the user in response to the request given from the user. Herein, the “information transmitted by the course distributing unit” is defined as text data containing information on a method of utilizing the usage equipment, e.g., the information showing a knack of using a search engine and know-how of a net auction. Note that contents of the information transmitted by the course distributing unit are recorded in the user information storage unit.

Herein, the analyzing unit analyzes the data in the user information storage unit and the data in the access recording unit. To be specific, the analyzing unit retrieves a relationship between the course utilized (participated) by the user and the profile of the user from the data in the user information storage unit. For example, the analyzing unit compares a magnitude of a course participant count of each course with the user's profile, and analyzes the course needed by the user according to the age group and the distinction of sex. Further, the analyzing unit analyzes, based on the data in the access recording unit, a relationship between the category of the Web page accessed by the user and the user's profile. For example, the analyzing unit compares a magnitude of the access count of the user and the user's profile, and analyzes the category of the information in which the user has an interest according to the age group and the distinction of sex. Then, the analyzing unit extracts, from within the plurality of courses stored in the course information storage unit, the course coincident with a relationship between the user's profile, the participation course and the category of the Web page.

Next, the announcement distributing unit transmits the text data of the announcement of the course matching with the course extracted by the analyzing unit to the usage equipment of the user.

The scheme described above enables the information processing device according to the present invention to provide the information for effectively utilizing the usage equipment of the user along with the favorite of the user.

It should be noted that the user information storage unit may be further stored with information on the usage equipment employed by the user, and the analyzing unit may extract the course effective in using the usage equipment that is stored in the user information storage unit from within the courses stored in the course information storage unit. With this scheme, only the information of the course related to the usage equipment employed by the user is distributed thereto.

Further, the identifying information may contain an identification number for identifying the user and a password. This scheme enables the user to be surely identified.

Still further, the information on the profile of the user may contain a distinction of sex and an age group of the user. With this scheme, the favorite of the user can be analyzed according to the distinction of sex and the age group of the user.

Still further, the announcement distributing unit may transmit, to the usage equipment of the user, the announcement of the course in a way that registers the text data of the announcement of the course into the Web page provided to the user. With this scheme, the user, when accessing the Web page, can recognize the announcement information.

Moreover, the announcement distributing unit may transmit, to the usage equipment of the user, the announcement of the course in a way that registers the text data of the announcement of the course into an electronic mail provided to the user. This scheme enables the announcement information to be provided to the user who does not access the Web page.

Additionally, the information processing device may further comprise an authenticating unit requesting, when receiving an access from the user via the input/output unit, the user to transmit identifying information, and authenticating the access of the user if the transmitted data is coincident with the identifying information stored in the user information storage unit.

Moreover, the present invention may also be an information processing method by which any one of the functions described above is carried out. Further, the present invention may also be an information processing program that makes a computer execute any one of the functions described above. Yet further, the present invention may also be a readable-by-computer recording medium recorded with the information processing program.

It is possible to provide the information for effectively utilizing the usage equipment of the user along with the favorite of the user.

### BRIEF DESCRIPTION OF THE DRAWINGS

FIG. 1 is a diagram of a whole configuration of a Web server;

FIG. 2A is a diagram showing one example of contents of a user information database;

FIG. 2B is a diagram showing one example of contents of an access log database;

FIG. 2C is a diagram showing one example of contents of a seminar database;

FIG. 3 is a flowchart of processes by the Web server; and

FIG. 4 is a diagram showing one example of contents of an announcement of a course.

### DETAILED DESCRIPTION OF THE INVENTION

An information processing device, an information processing method and an information processing program according to a preferred embodiment of the present invention will hereinafter be described with reference to the drawings. The embodiment is an exemplification, and the present invention is not limited to the exemplification.

<Configuration>

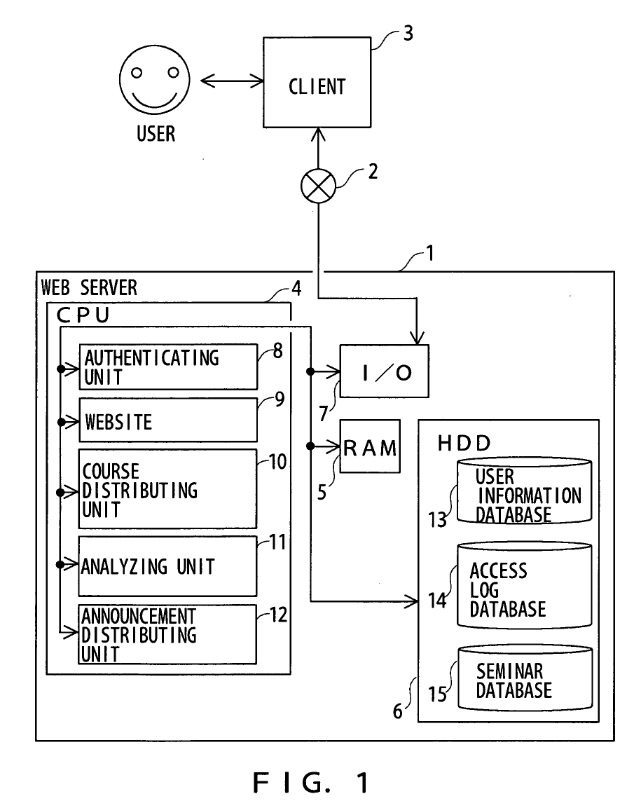

FIG. 1 is a diagram of a whole configuration, showing a Web server 1 in the embodiment, a communication network 2 connected to the Web server 1, and a client 3 connected to the communication network 2. As illustrated in FIG. 1, the Web server 1 has a communication-enabled configuration with the client 3 via the communication network 2. The Web server 1 is a server computer operated by an information provider who provides various categories of information services, and is installed in an office building etc of the information provider. The communication network 2 is a computer network using TCP/IP (Transmission Control Protocol/Internet Protocol) protocol and is exemplified by the Internet. The client 3 is a personal computer possessed by the user, and is installed in a house etc of the user. Note that the embodiment is based on such a premise that the client 3 is a personal computer, however, the present invention is not limited to the personal computer and may also be, for example, a mobile phone and a portable information terminal such as a PDA (Personal Digital Assistant), which include a WWW Browser. Further, an assumption in FIG. 1 is that though only one client 3 is illustrated, a multiplicity of clients 3 is connected to the communication network 2.

The Web server 1 is constructed of a CPU (Central Processing Unit) 4, a memory 5, a hard disk 6 and an input/output interface 7. The CPU 4 executes an information processing program stored in the hard disk 6 etc and cooperates in function with the memory 5 and the input/output interface 7, thereby realizing an authenticating unit 8, a Website 9, a course distributing unit 10, an analyzing unit 11 and an announcement distributing unit 12. Further, the hard disk 6 performs roles of the [a user information storage unit], [an access recording unit] and [a course information storage unit] according to the present invention, and a user information database 13, an access log database 14 and a seminar database 15 are build up in an interior of the hard disk 6.

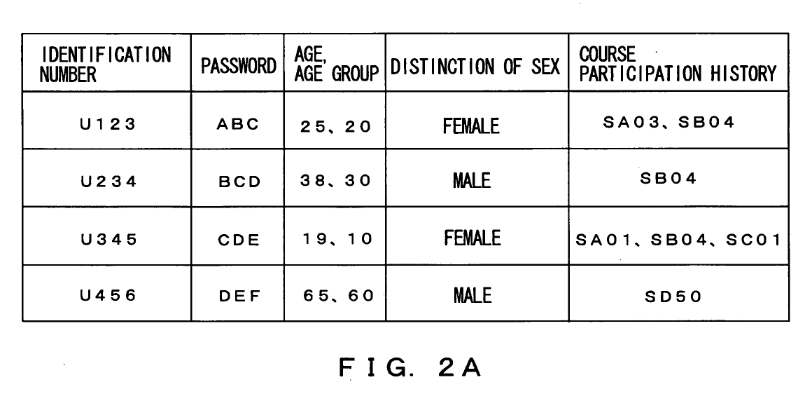

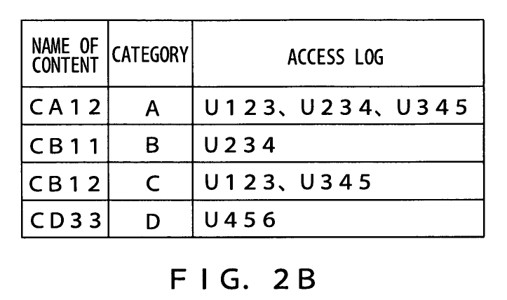

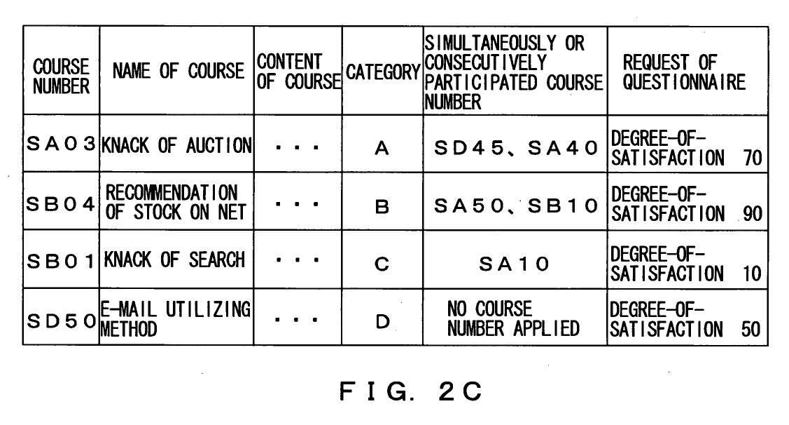

The user information database 13 is organized by pieces of information for identifying users, pieces of information on profiles of the users, pieces of information on seminars in which the users have participated so far, and so on. FIG. 2A illustrates one example of contents of the user information database 13. As shown in FIG. 12A, the identifying information consists of an identification number, a password, etc for identifying the user. Further, the information on the profile of the user consists of, e.g., a distinction of sex, an age group, etc of the user. Still further, the information on the seminars in which the user has participated so far consists of course numbers of the seminars, and so on. Note that the user information database 13 may contain pieces of information about the clients 3 employed by the users.

The access log database 14 is organized by access logs of the users who accessed the Website 9. FIG. 2B shows one example of contents of the access log database 14. As shown in FIG. 2B, the access log database 14 contains the identification numbers of the users accessing the Website 9, in which the identification numbers are stored according to every name of the content within the Website 9. Note that the access log database 14 also contains the information on categories to which the respective contents within the Website 9 belong.

The seminar database 15 is organized by items of information on the contents of the seminars and histories of course participants. FIG. 2C shows one example of contents of the seminar database 15. As illustrated in FIG. 2C, the seminar database 15 is stored with items of data concerning names of the courses, contents of the courses (i.e., text-formatted data representing the way and a knack of using a search engine, know-how of net auctions, the way of using word processing software, the way of using spreadsheet software, etc) according to every course number of the seminar. Moreover, the seminar database 15 is also stored with items of information on the categories of the seminars, course numbers of the courses in which the users participated simultaneously or consecutively, and results of questionnaires of the users participating in the courses.

The authenticating unit 8 has a Web page of a login screen for requesting the user to input the identifying information. Then, the authenticating unit 8, when the user accesses the Web server 1, transmits data of the Web page of the login screen to the client 3 of this user, and prompts the user to input the identifying information. The authenticating unit 8, when receiving the identifying information sent from the client 3, refers to the user information database 13 and detects coincidence or discrepancy between the identification numbers and between the passwords.

The Website has a plurality of Web pages different in their categories (such as a Web page for the net auction and a Web page describing information on cooking). Then, the Website 9 transmits the data of the Web page to the client 3 accessing the Web server 1 and authenticated by the authenticating unit 8. Note that the Website 9 edits the access log database 14 after transmitting the data of the Web page, and records the user's identification number in an access log field of the content name associated with the provided Web page.

The course distributing unit 10, when receiving a transmission request from the client 3, transmits text data having course contents of the seminar for effectively utilizing the client 3 via the input/output interface 7 to the client 3. The course contents are provided to the client 3 as a mail-based seminar by E-mail and as the Web page in a format accessible from the communication network 2. Note that the course distributing unit 10, after distributing the course contents to the client 3, edits the user information database 13, and records the course number of the distributed course in a course participation history field associated with the identification number of the user provided with the course contents.

The analyzing unit 11 starts analyzing a favorite of the user, for example, according to a predetermined schedule and in response to a command given from an operator. The analyzing unit 11, at first, refers to the user information database 13 and rearranges the items of data about the age groups and the distinctions of sexes of the users participating in the seminar according to every course number. Through this rearrangement, the age groups and the distinctions of sexes of the users participating in the respective courses are totalized for every course number. For example, in the case of FIG. 2A, the items of data are rearranged into a row (a record) showing that the female in her twenties participated in the course specified by the course number SA03 and into rows (records) showing that the male in his thirties and the female in her teens participated in the course specified by the course number SB04. A relationship between the participating courses and the profiles of the users participating in the courses, which are acquired by thus rearranging the items of data, is set as a filtering condition used when filtering the courses to be announced. The data of the filtering condition prescribing the relationship between the participating courses and the profiles will hereinafter be referred to as first filtering condition data.

Next, the analyzing unit 11 refers to the access log database 14, and rearranges the age groups and the distinctions of sexes of the users accessing the Web on a category-by-category basis of the Web page. The age groups and the distinctions of sexes of the users accessing the respective Websites are thereby totalized on the category-by-category basis. For example, in the case of FIG. 2B, items of data are rearranged into the row (the record) showing that the male and the females in their teens, twenties and thirties accessed the Web page of the category A, the row showing that the male in his thirties had the access to the category B, and the row showing that the male in his sixties had the access to the category D. A relationship between the categories of the Web pages and the profiles of the users accessing the Web pages, which are acquired by thus rearranging the items of data, is set as a filtering condition used when filtering the courses to be announced. The data of the filtering condition prescribing the relationship between the categories of the Web pages and the profiles will hereinafter be referred to as second filtering condition data.

Next, the analyzing unit 11 searches the multiplicity of courses stored in the seminar database 15 for the course number that satisfies the condition of the first filtering condition data and the condition of the second filtering condition data. To be specific, the analyzing unit 11 acquires the profile of the user to whom the announcement of the course is to be provided, then extracts the course, in which the user belonging to the age group and the distinction of sex each coincident with the user's profile participates, with reference to the first filtering condition data from within the multiplicity of courses stored in the seminar database 15, and next extracts the course coincident with the category of the information accessed by the user belonging to the age group and the distinction of sex each coincident with the user's profile with reference to the second filtering condition data. For example, the analyzing unit 11 analyzes the course that should be announced to the female in her twenties, in which case the analyzing unit 11 searches for the course number, i.e., the course number SA03 coincident with the course numbers (i.e., the course numbers SA03 and SA04) satisfying the first filtering condition and with the categories (i.e., the categories A and C) satisfying the second filtering condition.

The announcement distributing unit 12 transmits the text data about the announcement of the course (the name of the course) via the input/output interface 7 to the client 3. Namely, the announcement distributing unit 12, when transmitting the announcement of the course, refers to the user information database 13, and thus acquires the data about the age group and the distinction of sex of the user to whom the announcement of the course is to be provided. Then, the announcement distributing unit 12 transmits the text data of the announcement of the course to the user matching with the analyzed result output by the analyzing unit 11. In the example given above, the participation in the course specified by the course number SA03 is recommended to the female in her twenties from the analyzed result of the analyzing unit 11. Hence, all the identification numbers of the females in their twenties are extracted from within the user information database 13, and the announcement of the course specified by the course number SA03 is distributed (multicast) to the users identified by the extracted identification numbers. With this scheme, the announcement of the seminar, which invokes a growing interest among the females in their twenties, is distributed to all the female users in their twenties registered in the user information database 13. Note that the announcement distributing unit 12 refers to a result of the questionnaire about each of the courses in the seminar database 15, and may remove the announcement of a disrepute course that does not satisfy a desired threshold value.

<Processing Flow>

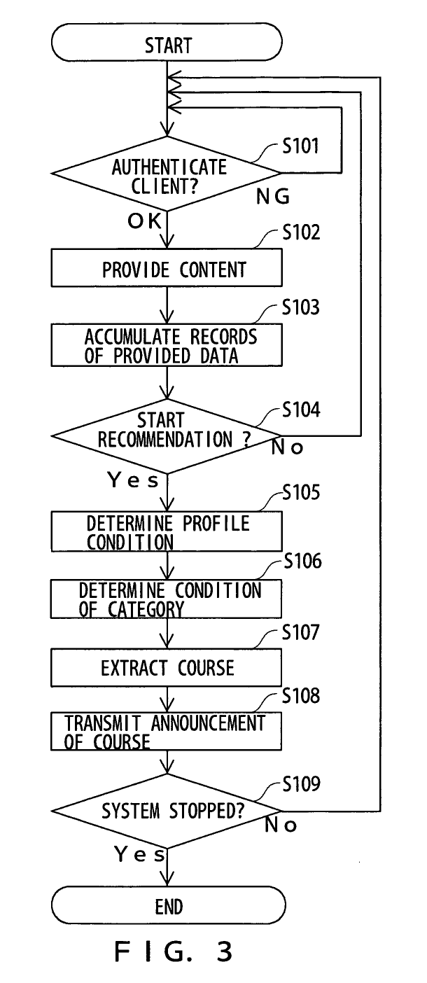

Next, a processing flow of the Web server 1 according to one embodiment of the information processing method of the present invention will hereinafter be described. FIG. 3 is a flowchart showing the processes by the Web server 1. A flow of the information processing by the Web server 1 will hereinafter be described with reference to the flowchart in FIG. 3.

(Step S101: Authentication of Client) To begin with, the authenticating unit 8 requests the client 3 accessing the Web server 1 to input the identifying information. Then, the authenticating unit 8 performs an operation of authenticating the user who has accessed. If the user information database 13 contains none of the data coincident with the identifying information of which the client 3 has notified, the authenticating unit 8 rejects the access of the client 3. Whereas if the user information database 13 contains the data coincident with the identifying information of which the client 3 has notified, the authenticating unit 8 permits the access of the client 3. It should be noted that this step corresponds to an [authenticating step] according to the present invention.

(Step S102: Provision of Content) If the client 3 is authenticated in step S101, next, the Website 9 and the course distributing unit 10 transmit the data to the client 3. The Website 9 and the course distributing unit 10 transmit the data of the Web page and the text data of the contents of the course in response to the request given from the client 3. It should be noted that this step corresponds to a [course distributing step] according to the present invention.

(Step S103: Accumulation of Records of Provided Data) Next, the Website 9 and the course distributing unit 10, after transmitting the data to the client 3 (step S102), update the transmission records of the data (i.e., the [course participation history] shown in FIG. 2A and the [access log] shown in FIG. 2B) by editing the data in the access log database 14 and the data in the seminar database 15. The items of data for analyzing the favorite of the user are thereby accumulated. It should be noted that this step corresponds to an [access recording step] and a [course participation history updating step] according to the present invention.

(Step S104: Analysis of User's Favorite) Next, the analyzing unit 11 analyzes the data in the access log database 14 and the data in the seminar database 15, and thus acquires a tendency of the user's favorite. The analyzing unit 11 starts analyzing the data in the respective databases on the basis of settings in a preset schedule and in response to a request of the operator.

(Step S105: Determination of Profile-Based Filtering Condition) Subsequently, the analyzing unit 11 rearranges the data of the age groups and the distinctions of sexes of the users participating in the seminar according to every course number, and totalizes the age groups and the distinctions of sexes of the users participating in the respective courses according to every course number. This step corresponds to a [first filtering condition searching step] according to the present invention.

(Step S106: Determination of Category-Based Filtering Condition) Next, the analyzing unit 11 rearranges the age groups and the distinctions of sexes of the users accessing the Web pages on the category-by-category basis of the Web pages, and totalizes the main age groups and the distinctions of sexes of the users accessing the respective Websites on the category-by-category basis. This step corresponds to a [second filtering condition searching step] according to the present invention.

(Step S107: Extraction of Course) Subsequently, the analyzing unit 11 retrieves, from within the course numbers stored in the seminar database 15, the course number that satisfies both of the filtering condition determined in step S105 and the filtering condition determined in step S106. This step corresponds to an [analyzing step] according to the present invention.

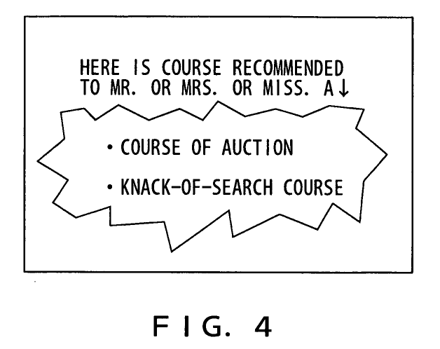

(Step S108: Provision of Information) Subsequently, the announcement distributing unit 12 transmits the text data of the announcement of the course to the client 3. The announcement of the course transmitted by the announcement distributing unit 12 is information associated with the course specified by the course number retrieved in step S107. FIG. 4 shows one example of the contents of the announcement information transmitted by the announcement distributing unit 12. As illustrated in FIG. 4, the announcement of the course, which is transmitted by the announcement distributing unit 12, is organized by the contents for introducing an auction course and a knack-of-search course for effectively utilizing the client 3. It should be noted that this step corresponds to an [announcement distributing step] according to the present invention.

<Effects>

Owing to what has been done so far, the Web server 1 according to one embodiment of the present invention analyzes the favorite of the user on the basis of the record etc of the provided information accumulated in the database, and can therefore provide the information for effectively utilizing the usage equipment of the user along with the favorite of the user.

<Readable-by-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

What is claimed is:

1. An information processing device comprising:
an input/output unit used for performing communications with usage equipment of a user via a communication network;
a user information storage unit stored with identifying information for identifying the user, information on a profile of the user and information on a course participation history of a course in which the user participated;
a Website accessed by the user and organized by a plurality of Web pages in different categories;
an access recording unit recording information on the user accessing the Website;
a course information storage unit stored with text data of contents of the course that contains information on a usage method of the usage equipment and with text data of an announcement of the course that summarizes the contents of the course;
a course distributing unit transmitting, when receiving a request from the user, the text data of contents of the course to the usage equipment of the user via the input/output unit, and updating the course participation history stored in the user information storage unit;
an analyzing unit searching for a relationship between the course in which the user participated and a profile of the user by referring to the user information storage unit, searching for a relationship between the category of the Web page accessed by the user and the profile of the user by referring to the access recording unit, and extracting, from within the courses stored in the course information storage unit, the course that satisfies conditions of the searched relationships between the profile of the user, the participation course and the category of the Web page; and
an announcement distributing unit searching the course information storage unit for the text data of the announcement of the course matching with the course extracted by the analyzing unit, and transmitting the searched text data of the announcement of the course to the usage equipment of the user.

2. The information processing device according to claim 1, wherein the user information storage unit is further stored with information on the usage equipment employed by the user, and
the analyzing unit extracts the course effective in using the usage equipment that is stored in the user information storage unit from within the courses stored in the course information storage unit.

3. The information processing device according to claim 1, wherein the identifying information contains an identification number for identifying the user and a password.

4. The information processing device according to claim 1, wherein the information on the profile of the user contains a distinction of sex and an age group of the user.

5. The information processing device according to claim 1, wherein the announcement distributing unit transmits, to the usage equipment of the user, the announcement of the course in a way that registers the text data of the announcement of the course into the Web page provided to the user.

6. The information processing device according to claim 1, wherein the announcement distributing unit transmits, to the usage equipment of the user, the announcement of the course in a way that registers the text data of the announcement of the course into an electronic mail provided to the user.

7. The information processing device according to claim 1, further comprising an authenticating unit requesting, when receiving an access from the user via the input/output unit, the user to transmit identifying information, and authenticating the access of the user if the transmitted data is coincident with the identifying information stored in the user information storage unit.

8. An information processing method comprising:
an access recording step of recording, in an access recording unit, information on a user accessing a Website, for an access by the user, organized by a plurality of Web pages in different categories;
a course distributing step of transmitting, when receiving a request from the user, text data of contents of a course containing information on a usage method of usage equipment of the user to the usage equipment of the user via input/output unit;
a course participation history updating step of updating, based on the course contents distributed in the course distributing step, a course participation history stored in a user information storage unit;
a first filtering condition searching step of searching for a relationship between the course in which the user participated and a profile of the user by referring to the user information storage unit;
a second filtering condition searching step of searching for a relationship between the category of the Web page accessed by the user and the profile of the user by referring to the access recording unit;
an analyzing step of extracting the course that satisfies the conditions of the relationships between the profile of the user, the participation course and the category of the Web page, which have been searched for in the first filtering condition searching step and in the second filtering condition searching step; and
an announcement distributing step of transmitting text data of contents of the course matching with the course extracted by in the analyzing step to the usage equipment of the user.

9. The information processing method according to claim 8, wherein the user information storage unit is further stored with information on the usage equipment employed by the user, and
the analyzing step includes extracting the course effective in using the usage equipment that is stored in the user information storage unit from within the courses stored in the course information storage unit.

10. The information processing method according to claim 8, wherein the user information storage unit is stored with the identifying information containing an identification number for identifying the user and a password.

11. The information processing method according to claim 8, wherein the user information storage unit is stored with the information on the profile of the user, which contains a distinction of sex and an age group of the user.

12. The information processing method according to claim 8, wherein the announcement distributing step includes transmitting, to the usage equipment of the user, the announcement of the course in a way that registers the text data of the announcement of the course into the Web page provided to the user.

13. The information processing method according to claim 8, wherein the announcement distributing step includes transmitting, to the usage equipment of the user, the announcement of the course in a way that registers the text data of the announcement of the course into an electronic mail provided to the user.

14. The information processing method according to claim 8, further comprising an authenticating step of requesting, when receiving an access from the user via the input/output unit used for performing the communications with the usage equipment of the user through the communication network, the user to transmit identifying information, and authenticating the access of the user if the transmitted data is coincident with the identifying information stored in the user information storage unit stored with the identifying information for identifying the user, the information on the profile of the user, the information on the course participation history of the course in which the user participated.

15. A recoding medium recorded an information processing program for making a computer execute:
an access recording step of recording, in an access recording unit, information on a user accessing a Website, for an access by the user, organized by a plurality of Web pages in different categories;
a course distributing step of transmitting, when receiving a request from the user, text data of contents of a course containing information on a usage method of usage equipment of the user to the usage equipment of the user via input/output unit;
a course participation history updating step of updating, based on the course contents distributed in the course distributing step, a course participation history stored in a user information storage unit;
a first filtering condition searching step of searching for a relationship between the course in which the user participated and a profile of the user by referring to the user information storage unit;
a second filtering condition searching step of searching for a relationship between the category of the Web page accessed by the user and the profile of the user by referring to the access recording unit;
an analyzing step of extracting the course that satisfies the conditions of the relationships between the profile of the user, the participation course and the category of the Web page, which have been searched for in the first filtering condition searching step and in the second filtering condition searching step; and
an announcement distributing step of transmitting text data of contents of the course matching with the course extracted by in the analyzing step to the usage equipment of the user.

16. The recoding medium recorded the information processing program according to claim 15, wherein the user information storage unit is further stored with information on the usage equipment employed by the user, and
the analyzing step includes extracting the course effective in using the usage equipment that is stored in the user information storage unit from within the courses stored in the course information storage unit.

17. The recoding medium recorded the information processing program according to claim 15, wherein the user information storage unit is stored with the identifying information containing an identification number for identifying the user and a password.

18. The recoding medium recorded the information processing program according to claim 15, wherein the user information storage unit is stored with the information on the profile of the user, which contains a distinction of sex and an age group of the user.

19. The recoding medium recorded the information processing program according to claim 15, wherein the announcement distributing step includes transmitting, to the usage equipment of the user, the announcement of the course in a way that registers the text data of the announcement of the course into the Web page provided to the user.

20. The recoding medium recorded the information processing program according to claim 15, wherein the announcement distributing step includes transmitting, to the usage equipment of the user, the announcement of the course in a way that registers the text data of the announcement of the course into an electronic mail provided to the user.
